(19) United States
(12) Patent Application Publication
(10) Pub. No.: US 2026/0251216 A1
(43) Pub. Date: Aug. 27, 2026

(54) TRANSMISSION CONTROLLER AND VEHICLE

(71) Applicant: KAWASAKI MOTORS, LTD., Hyogo (JP)

(72) Inventors: Shohei MIZUISHI, Akashi-shi (JP); Tomoki TADA, Akashi-shi (JP); Rui FUKUOKA, Akashi-shi (JP); Koshi FUSAZAKI, Akashi-shi (JP); Naoya ISOZAKI, Akashi-shi (JP); Takuya MIZOGUCHI, Akashi-shi (JP)

(21) Appl. No.: 19/544,331

(22) Filed: Feb. 19, 2026

(30) Foreign Application Priority Data
Feb. 21, 2025 (JP) 2025-026793

(51) Int. Cl. F16H 61/16; F16H 3/091; F16H 59/44

(52) U.S. Cl. CPC F16H 61/16; F16H 59/44; F16H 3/091; F16H 2061/163; F16H 2061/168

(57) ABSTRACT

Provided are a transmission controller and a vehicle capable of reducing free-running travel in a case where a gear stage of a transmission becomes a neutral gear stage contrary to a driver's intention. A vehicle 1 includes a transmission 6, an actuator 7 that operates to selectively switch a gear stage of the transmission 6, and a transmission controller 9 that issues an operation command for switching the gear stage to the actuator 7. The transmission controller 9 issues an operation command to the actuator 7 to perform a shift operation for switching the gear stage to the first gear stage or the second gear stage and a retry operation for switching the gear stage to the first gear stage or the second gear stage according to a predetermined value indicating the traveling state of the vehicle 1 when the gear stage switched based on the shift operation becomes the neutral gear stage contrary to the shift operation.

### CROSS-REFERENCE TO RELATED APPLICATIONS

The present application claims priority to JP 2025-026793 filed 21 Feb. 2025, of which is incorporated herein by reference.

### TECHNICAL FIELD

The present disclosure relates to a transmission controller and a vehicle.

### BACKGROUND ART

Patent Document 1 discloses a transmission control device for a motorcycle that performs a clutch operation and a shift operation using power of an electric motor based on a shift command of a driver.

### PATENT DOCUMENTS

Patent Document 1: JP 4146465 B

### SUMMARY

In a case where a driver inputs, for example, a shift command for upshift to the control device in traveling of the motorcycle on which such a control device is mounted, the gear stage of the transmission may be switched to a neutral gear stage contrary to an intention of the driver. In such a case, since the motorcycle can travel in a so-called free-running state in which the driving force of the drive source is not transmitted to the drive wheel, coasting sensation is experienced. Therefore, there is room for further contrivance from the viewpoint of reducing the free-running state caused by unintentionally switching the gear stage to the neutral gear stage.

An object of the present disclosure is to provide a transmission controller and a vehicle capable of reducing free-running travel in a case where a gear stage of a transmission becomes a neutral gear stage contrary to a driver's intention.

One aspect of the present disclosure provides a transmission controller that issues an operation command for switching a gear stage to an actuator in a vehicle, the vehicle comprising:
a drive wheel;
a drive source that generates a driving force for rotating the drive wheel;
a transmission that transmits the driving force to the drive wheel by a specific gear stage selected from a plurality of gear stages including at least a first gear stage, a second gear stage having a higher gear ratio than a gear ratio of the first gear stage, and a neutral gear stage not transmitting the driving force; and
an actuator that operates to selectively switch gear stages,
wherein the transmission controller issues to the actuator an operation command including:
a shift operation for switching the gear stage to the first gear stage or the second gear stage; and
a retry operation for switching the gear stage to the first gear stage or the second gear stage according to a predetermined value indicating a traveling state of the vehicle in a case where the gear stage switched based on the shift operation becomes the neutral gear stage contrary to the shift operation.

Another aspect of the present disclosure provides a vehicle comprising:
a drive wheel;
a drive source that generates a driving force for rotating the drive wheel;
a transmission that transmits the driving force to the drive wheel by a specific gear stage selected from a plurality of gear stages including at least a first gear stage, a second gear stage having a higher gear ratio than a gear ratio of the first gear stage, and a neutral gear stage not transmitting the driving force;
an actuator that operates to selectively switch gear stages; and
a transmission controller that issues an operation command to the actuator for switching a gear stage,
wherein the transmission controller issues to the actuator an operation command including:
a shift operation for switching the gear stage to the first gear stage or the second gear stage; and
a retry operation for switching the gear stage to the first gear stage or the second gear stage according to a predetermined value indicating a traveling state of the vehicle in a case where the gear stage switched based on the shift operation becomes the neutral gear stage contrary to the shift operation.

According to the transmission controller and the vehicle of the present disclosure, even in a case where the gear stage becomes the neutral gear stage contrary to the intention of the driver, an operation command of a retry operation for switching the gear stage to a first gear stage or a second gear stage is issued to an actuator in accordance with the traveling state of the vehicle. As a result, free-running travel can be reduced, and the coasting sensation is reduced.

### BRIEF DESCRIPTION OF DRAWINGS

FIG. 1 is a right side view of a vehicle according to the present embodiment;

FIG. 2 is a schematic diagram of a power system of the vehicle according to the present embodiment;

FIG. 3 is a schematic cross-sectional view illustrating an operation of a restraining body according to the present embodiment;

FIG. 4 is a block diagram illustrating a transmission controller and input and output thereof according to the present embodiment; and

FIG. 5 is a flowchart illustrating an example of a method of controlling a transmission using the transmission controller according to the present embodiment.

### DETAILED DESCRIPTION

Hereinafter, embodiments of the present disclosure will be described with reference to the accompanying drawings.

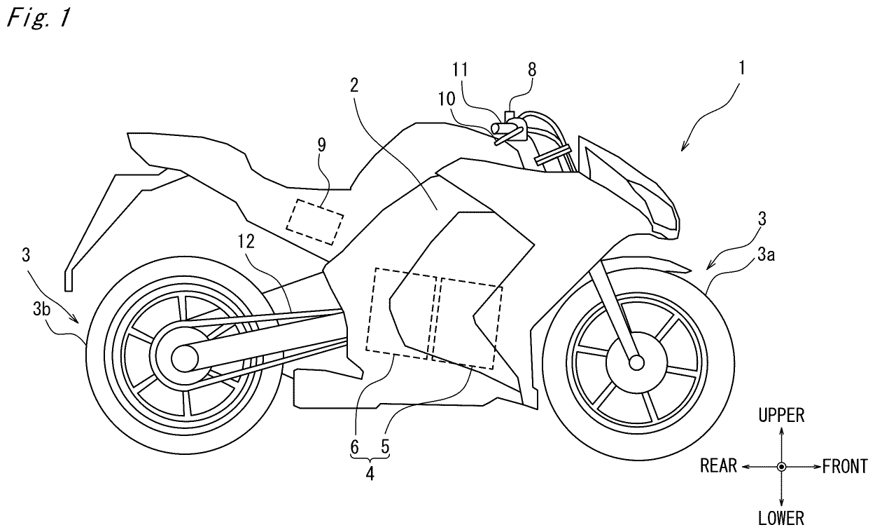

FIG. 1 is a right side view of a vehicle 1 according to the present embodiment. The vehicle 1 is a motorcycle. The vehicle 1 of FIG. 1 is partially illustrated in a simplified manner for easy understanding. In the present specification, “front”, “rear”, “left”, and “right” refer to a front direction, a rear direction, a left direction, and a right direction as viewed from a driver in the vehicle 1. A height direction of the vehicle 1 is defined as a vertical direction. For example, a left-right direction corresponds to a vehicle width direction of the vehicle 1.

The vehicle 1 includes a vehicle body frame 2, wheels 3 supported by the vehicle body frame 2, and a drive assembly 4 that drives the wheels 3. Among the wheels 3, a wheel provided in front of the vehicle 1 is a driven wheel 3a, and a wheel provided in rear of the vehicle 1 is a drive wheel 3b. The drive assembly 4 is disposed between the driven wheel 3a and the drive wheel 3b in the front-rear direction.

The drive assembly 4 includes a drive source 5 that generates a driving force for rotating the drive wheel 3b, and a transmission 6 that can transmit the driving force from the drive source 5 to the drive wheel 3b. The drive source 5 is, for example, an engine. The drive source 5 may include an electric motor instead of or in addition to the engine. When a specific gear stage is selected from the plurality of gear stages, the transmission 6 shifts the driving force transmitted from the engine to a gear ratio of the selected gear stage, and transmits the driving force to the drive wheel 3b via a driving force transmitter 12 (for example, a chain) provided in the vehicle 1.

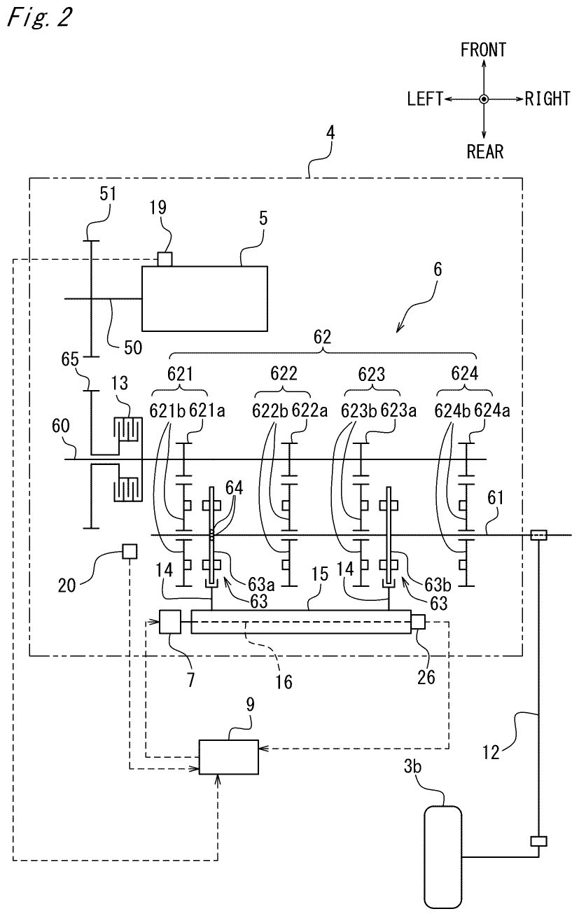

The vehicle 1 further includes a shift switch 8 for switching gear stages, and a transmission controller 9 that issues an operation command for switching the gear stages based on an operation of the shift switch 8. The transmission controller 9 may be included in an electronic control unit (ECU) that controls any system of the vehicle 1. The transmission controller 9 is electrically connected to the shift switch 8, an actuator 7 (see FIG. 2) to be described later, and various sensors to be described later.

The shift switch 8 is provided near a steering handle of the vehicle 1. When the driver operates the shift switch 8 during traveling, the transmission controller 9 transmits, to the actuator 7, an upshift operation command for raising the gear stage or a downshift operation command for lowering the gear stage. An acceleration operator 11 and a brake operator 10 of the vehicle 1 are further provided near the steering handle. In the present embodiment, the acceleration operator 11 is a throttle operator, and the brake operator 10 is a brake lever.

FIG. 2 schematically illustrates a power system of the vehicle 1. In addition to the drive source 5 and the transmission 6, the drive assembly 4 includes a shift fork 14, a shift drum 15, and the actuator 7 configured to selectively switch a gear stage of the transmission 6. The drive assembly 4 further includes a clutch 13 for transmitting or interrupting the driving force from the drive source 5 to the transmission 6.

The drive source 5 includes a drive source output shaft 50 that rotates by the operation of the drive source 5, and a drive gear 51 for transmitting a driving force to the transmission 6. The drive source output shaft 50 extends in the vehicle width direction of the vehicle 1, that is, in the left-right direction. The drive gear 51 is fixed to the drive source output shaft 50 and rotates integrally with the drive source output shaft 50. A drive source output shaft rotation speed sensor 19 is attached to the drive source 5. The drive source output shaft rotation speed sensor 19 detects the rotation speed of the drive source output shaft 50. The drive source output shaft rotation speed sensor 19 is electrically connected to the transmission controller 9.

The transmission 6 includes a driven gear 65 to which the driving force is transmitted from the drive gear 51, a main shaft 60 to which the driving force is transmitted from the driven gear 65 via the clutch 13, a plurality of gear pairs 62 for converting the driving force, and a counter shaft 61 for transmitting the converted driving force to the drive wheel 3b. The main shaft 60 and the counter shaft 61 extend in parallel with the drive source output shaft 50, that is, in the vehicle width direction. A counter shaft rotation speed sensor 20 is attached to the transmission 6. The counter shaft rotation speed sensor 20 detects the rotation speed of the counter shaft 61. The counter shaft rotation speed sensor 20 is electrically connected to the transmission controller 9.

In the present embodiment, the plurality of gear pairs 62 includes four gear pairs, that is, first gear pair 621 to fourth gear pair 624. The first gear pair 621 is a gear pair for transmitting the driving force in the first gear stage. The second gear pair 622 is a gear pair for transmitting the driving force in the second gear stage. The third gear pair 623 is a gear pair for transmitting the driving force in the third gear stage. The fourth gear pair 624 is a gear pair for transmitting the driving force in the fourth gear stage. The first gear stage is a gear stage at which the driving force is transmitted at the lowest gear ratio in each gear stage. The second gear stage is a gear stage at which the driving force is transmitted at the second lowest gear ratio in each gear stage. The third gear stage is a gear stage at which the driving force is transmitted at the third lowest gear ratio in each gear stage. The fourth gear stage is a gear stage at which the driving force is transmitted at the highest gear ratio in each gear stage.

In an alternative embodiment, the first gear stage may be a gear stage at which the driving force is transmitted at the third lowest gear ratio in each gear stage. In this case, the second gear stage may be a gear stage at which the driving force is transmitted at the highest gear ratio in each gear stage. The first gear stage is not limited to a gear stage at which the driving force is transmitted at the lowest gear ratio. In addition, the second gear stage is not limited to a gear stage at which the driving force is transmitted at the second lowest gear ratio in each gear stage. The second gear stage has a higher gear stage than a gear ratio of the first gear stage, that is, a driving force, in the second gear stage, having a speed greater than the driving force in the first gear stage.

Each of the first gear pair 621 to the fourth gear pair 624 includes a first main gear 621a to a fourth main gear 624a attached to the main shaft 60 and a first counter gear 621b to a fourth counter gear 624b attached to the counter shaft 61. The main gear 621a to the main gear 624a and the counter gear 621b to the counter gear 624b are configured to be in meshing engagement with each other. That is, in the transmission 6 of the present embodiment, a constant-mesh gear structure is adopted.

The first main gear 621a to the fourth main gear 624a are fixed in the axial direction and the rotational direction of the main shaft 60. That is, the first main gear 621a to fourth main gear 624a are attached to the main shaft 60 so as to rotate integrally with the main shaft 60.

The first counter gear 621b to the fourth counter gear 624b are fixed in the axial direction of the counter shaft 61 and are rotatable relative to the counter shaft 61. That is, the first counter gear 621b to the fourth counter gear 624b are rotatable independently of the rotation of the counter shaft 61.

The transmission 6 further includes a plurality of dogs 63 arranged at intervals in the axial direction of the counter shaft 61. The plurality of dogs 63 include a first dog 63a disposed between the first counter gear 621b and the second counter gear 622b, and a second dog 63b disposed between the third counter gear 623b and the fourth counter gear 624b. Each of the dogs 63a and 63b is fixed in the rotational direction of the counter shaft 61 and is movable in the axial direction of the counter shaft 61. That is, the dogs 63a and 63b are attached to the counter shaft 61 so as to rotate integrally with the counter shaft 61.

The first dog 63a is configured to be engageable with the first counter gear 621b or the second counter gear 622b. In a case where the first dog 63a and the first counter gear 621b are engaged with each other, the driving force from the main shaft 60 is transmitted to the counter shaft 61 via the first gear pair 621, that is, at the first gear stage. In a case where the first dog 63a and the second counter gear 622b are engaged with each other, the driving force from the main shaft 60 is transmitted to the counter shaft 61 via the second gear pair 622, that is, at the second gear stage. In a case where the first dog 63a is not engaged with either the first counter gear 621b or the second counter gear 622b, the driving force is not transmitted through at least the first gear pair 621 and the second gear pair 622.

The second dog 63b is configured to be engageable with the third counter gear 623b or the fourth counter gear 624b. In a case where the second dog 63b and the third counter gear 623b are engaged with each other, the driving force from the main shaft 60 is transmitted to the counter shaft 61 via the third gear pair 623, that is, at the third gear stage. In a case where the second dog 63b and the fourth counter gear 624b are engaged with each other, the driving force from the main shaft 60 is transmitted to the counter shaft 61 via the fourth gear pair 624, that is, at the fourth gear stage. In a case where the second dog 63b is not engaged with either the third counter gear 623b or the fourth counter gear 624b, the driving force is not transmitted through at least the third gear pair 623 and the fourth gear pair 624.

The shift fork 14 is connected to each of the dogs 63a and 63b. The shift drum 15 is connected to the shift fork 14. The shift drum 15 has a substantially cylindrical shape extending in the axial direction of the counter shaft 61, and is rotatably supported by a support shaft 16 similarly extending in the axial direction. A groove extending in the axial direction and the rotational direction is formed on an outer surface of the shift drum 15, and the shift fork 14 is fitted into the groove.

The actuator 7 is connected to one axial end of the shift drum 15. The actuator 7 is, for example, an electric motor. The actuator 7 is configured to rotate the shift drum 15 by a predetermined rotation angle. The actuator 7 may be directly connected to the shift drum 15 or may be connected to the shift drum 15 via a plurality of gears. When the shift drum 15 is rotated by the actuator 7, the shift fork 14 moves in the axial direction corresponding to the shape of the groove of the shift drum 15, whereby the respective dogs 63a and 63b move in the axial direction. That is, the gear stage is selectively switched by the operation of the actuator 7.

The shift drum 15 rotates with a detent feel so that a specific gear stage is selected from a plurality of gear stages. That is, the shift drum 15 can rotate between rotation angles so as to remain at a first shift rotation angle at which the first gear stage is selected, a second shift rotation angle at which the second gear stage is selected, a third shift rotation angle at which the third gear stage is selected, and a fourth shift rotation angle at which the fourth gear stage is selected. The shift drum 15 further remains at the neutral angle at which the neutral gear stage is selected. In the neutral gear stage, the first dog 63a and the second dog 63b are not engaged with any of the counter gear 621b to the counter gear 624b, and the driving force is not transmitted to the counter shaft 61. The neutral angle is located between the first shift rotation angle and the second shift rotation angle. For example, when the first shift rotation angle is 0°, the neutral angle is 72°, the second shift rotation angle is 144°, the third shift rotation angle is 216°, and the fourth shift rotation angle is 288°.

The state in which the gear stage is the neutral gear stage does not mean only the state in which the shift drum 15 remains at the neutral angle. The state in which the gear stage is the neutral gear stage includes a state in which the shift drum 15 remains at an angle that does not correspond to any of the first to fourth shift rotation angles and the neutral angle, due to malfunction of the actuator 7 or the like. For example, in the present embodiment, the state in which the gear stage is the neutral gear stage includes a state in which the shift drum 15 remains at an angle between the third shift rotation angle and the fourth shift rotation angle, for example, 250°.

The arrangement and structure of the gear pair 62, the dog 63, the shift fork 14, and the shift drum 15 are not limited thereto. A main gear rotatable relative to the main shaft and a dog engageable with the main gear may be disposed. In this case, the shift fork can be connected to a dog that engages with the main gear. The counter gear in meshing engagement with the main gear may be fixed to the counter shaft so as to rotate integrally with the counter shaft. The number of gear stages is not limited to four. The gear stages may be three or more gear stages or five or more gear stages.

A gear position sensor 26 is attached the shift drum 15. The gear position sensor 26 detects a rotation angle of the shift drum 15. The gear position sensor 26 is electrically connected to the transmission controller 9.

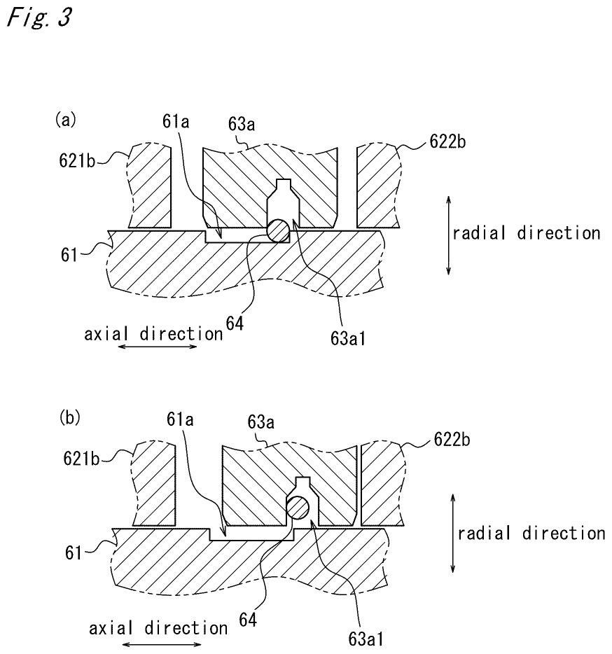

The transmission 6 further includes a restraining body 64 for restraining the gear stage to the first gear stage or the neutral gear stage. FIG. 3 is a cross-sectional view taken along the axial direction of the counter shaft 61. FIG. 3 illustrates a cross-sectional view of the counter shaft 61, the first counter gear 621b, the first dog 63a, the restraining body 64, and the second counter gear 622b. The restraining body 64 of the present embodiment is a plurality of steel balls.

FIG. 3(a) illustrates the arrangement of the restraining body 64 when the vehicle 1 is stopped. When the vehicle 1 stops, the restraining body 64 enters a groove 61a provided between the first counter gear 621b and the second counter gear 622b of the counter shaft 61, and a part of the restraining body 64 protrudes radially outward of the counter shaft 61 from the groove 61a. In other words, the diameter of the restraining body 64 is greater than the depth of the groove 61a of the counter shaft 61. Therefore, the movement of the first dog 63a in the axial direction toward the second counter gear 622b is limited by the restraining body 64. As a result, since the first dog 63a cannot be engaged with the second counter gear 622b, the gear stage cannot be switched to the second gear stage. In other words, the gear stage is restricted to the first gear stage or the neutral gear stage.

FIG. 3(b) illustrates the arrangement of the restraining body 64 when the vehicle 1 is traveling in the second gear stage. When the vehicle 1 is traveling at a specific vehicle speed or higher, the restraining body 64 rotates together with the counter shaft 61 about the axis of the counter shaft 61 since the counter shaft 61 rotates at a specific rotation speed corresponding to the vehicle speed. The restraining body 64 moves radially outward by a centrifugal force generated by the rotation. The inner diameter surface of the first dog 63a is provided with a hole 63a1 for receiving the restraining body 64. The diameter of the restraining body 64 is smaller than the depth of the hole 63a1 of the first dog 63a. Therefore, when the restraining body 64 that has moved radially outward is completely accommodated in the hole 63a1, the first dog 63a can move in the axial direction toward the second counter gear 622b. As a result, since the first dog 63a can be engaged with the second counter gear 622b, the gear stage can be switched to the second gear stage.

Therefore, when the vehicle speed is less than the specific vehicle speed, that is, when the rotation speed of the counter shaft is less than the specific rotation speed, the restraining body 64 restricts movement of the first counter gear 621b and restrains the gear stage to the first gear stage or the neutral gear stage. As a result, particularly when the vehicle 1 stops or decelerates, the gear stage is easily switched to the neutral gear stage. That is, when the vehicle 1 stops or decelerates, even if the driver mistakenly performs an operation to switch the gear stage to the second gear stage, the gear stage may remain in the first gear stage or the neutral gear stage.

The diameter, weight, and the like of the steel ball which is the restraining body 64 are designed so as to rise by a centrifugal force in a case where the vehicle speed is equal to or greater than a specific vehicle speed, that is, when the rotation speed of the counter shaft 61 is equal to or greater than a specific rotation speed. For example, the steel ball is designed to rise by a centrifugal force in a case where the vehicle speed is 20 km/h or more or the rotation speed of the counter shaft 61 is 600 rpm or more.

The driving force transmitted to the counter shaft 61 through any gear stage of the first to fourth gear stages is transmitted to the drive wheel 3b through the driving force transmitter 12 at a predetermined rotation speed and torque. The vehicle body frame 2 is provided with a wheel rotation speed sensor 18 that detects the rotation speed of the drive wheel 3b or the driven wheel 3a. The wheel rotation speed sensor 18 is electrically connected to the transmission controller 9.

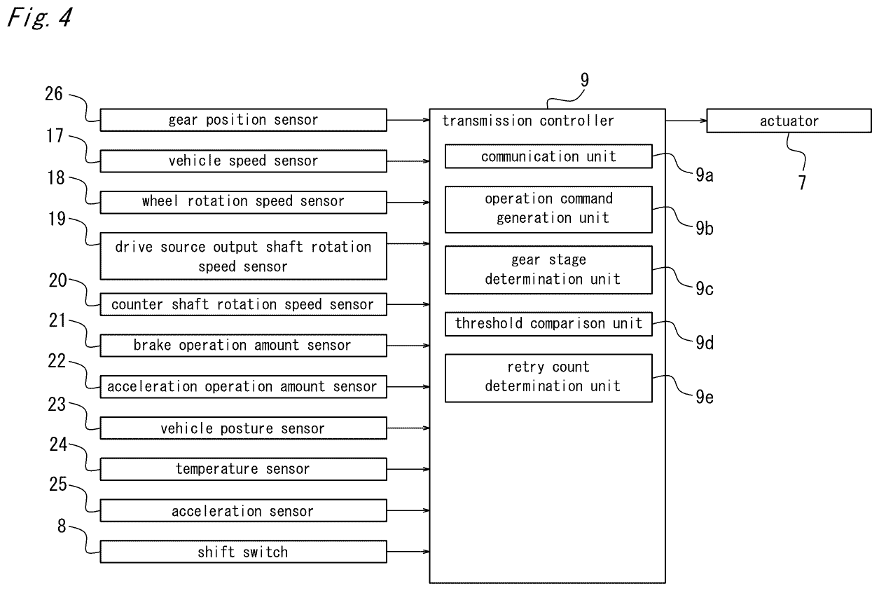

FIG. 4 is a block diagram illustrating the transmission controller 9 and input and output thereof. In addition to the sensors 18, 19, 20, and 26 and the shift switch 8 described above, the transmission controller 9 is electrically connected to a vehicle speed sensor 17, a brake operation amount sensor 21, an acceleration operation amount sensor 22, a vehicle posture sensor 23, a temperature sensor 24, and an acceleration sensor 25.

The vehicle speed sensor 17 is a sensor that detects the vehicle speed of the vehicle 1. The brake operation amount sensor 21 is a sensor that detects a movement amount of the brake operator 10. The acceleration operation amount sensor 22 is a sensor that detects a movement amount of the acceleration operator 11, that is, a throttle opening degree. The vehicle posture sensor 23 is a sensor that detects the inclination of the vehicle 1, that is, the bank angle. The temperature sensor 24 is a sensor that detects the temperature of a part or an element whose temperature tends to rise while the vehicle 1 is traveling. The temperature sensor 24 detects the temperature of the electric motor of the actuator 7. In a case where the drive source 5 includes an electric motor, the temperature sensor 24 may detect the temperature of the electric motor of the drive source 5. The acceleration sensor 25 is a sensor that detects acceleration in the traveling direction of the vehicle 1.

Various pieces of information detected by these sensors are input to the transmission controller 9. The transmission controller 9 receives, for example, information of a rotation angle of the shift drum 15 from the gear position sensor 26, a vehicle speed from the vehicle speed sensor 17, a rotation speed from each of the rotation speed sensors 18 to 20, a movement amount of the brake operator 10 from the brake operation amount sensor 21, a throttle opening from the acceleration operation amount sensor 22, a bank angle from the vehicle posture sensor 23, a temperature of each component from the temperature sensor 24, an acceleration of the vehicle 1 from the acceleration sensor 25, and a shift command (an upshift command or a downshift command) from the shift switch 8. That is, a predetermined value indicating the traveling state of the vehicle 1 is input to the transmission controller 9.

The transmission controller 9 includes, for example, a microprocessor as a main part. The transmission controller 9 includes a central processing unit (CPU), for example, a memory including a RAM and a ROM, and an input/output interface circuit. The transmission controller 9 processes information detected by the sensor and issues an operation command for switching the gear stage to the actuator 7. The actuator 7 operates based on the operation command of the transmission controller 9.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The transmission controller 9 includes a communication unit 9a, an operation command generation unit 9b, a gear stage determination unit 9c, a threshold comparison unit 9d, and a retry count determination unit 9e. The communication unit 9a, the operation command generation unit 9b, the gear stage determination unit 9c, the threshold comparison unit 9d, and the retry count determination unit 9e are, for example, programs or hardware written in a memory for executing their own functions.

The communication unit 9a receives information detected by various sensors and transmits an operation command to the actuator 7. The operation command generation unit 9b generates an operation command for the actuator 7. The gear stage determination unit 9c determines whether the gear stage is a neutral gear stage contrary to the shift command from the shift switch 8. The threshold comparison unit 9d compares the state of the vehicle 1 detected by various sensors with a predetermined threshold determined in advance. The retry count determination unit 9e determines whether the number of retry operations to be described later exceeds a predetermined number of times. Details are described below.

The transmission controller 9 issues an operation command to the actuator 7 for a shift operation for switching a gear stage based on the shift command from the shift switch 8. For example, in a case where the vehicle 1 is traveling at the first gear stage, when the driver performs an upshift operation to the second gear stage with the shift switch 8, the communication unit 9a receives information from the shift switch 8. The operation command generation unit 9b generates an operation command for the upshift from the first gear stage to the second gear stage, that is, a shift operation for rotating the shift drum 15 to the second shift rotation angle. The communication unit 9a transmits the operation command for the shift operation to the actuator 7.

Further, in a case where the gear stage becomes a neutral gear stage contrary to the shift operation, the transmission controller 9 issues an operation command to the actuator 7 to perform a retry operation for switching the gear stage to the first gear stage or the second gear stage according to a predetermined value indicating the traveling state of the vehicle 1. For example, the gear stage determination unit 9c determines whether the gear stage becomes a neutral gear stage contrary to the shift operation based on the rotation angle of the shift drum 15 obtained from the gear position sensor 26. The threshold comparison unit 9d compares the predetermined value with the threshold. The operation command generation unit 9b generates an operation command for a retry operation for switching the gear stage to the first gear stage or the second gear stage based on a comparison result between a predetermined value and a threshold. The communication unit 9a transmits the operation command for the retry operation to the actuator 7.

The predetermined value includes a first predetermined value related to the vehicle speed of the vehicle 1. That is, the transmission controller 9 issues an operation command to the actuator 7 to perform the retry operation according to the first predetermined value. The first predetermined value includes the vehicle speed, the rotation speed of the counter shaft 61, the rotation speed of the wheel 3, and the rotation speed of the drive source output shaft 50.

For example, in a case where the vehicle speed obtained from the vehicle speed sensor 17 is equal to or greater than the threshold of 20 km/h, the transmission controller 9 issues an operation command to the actuator 7 to perform a retry operation for switching the gear stage to the second gear stage. On the other hand, in a case where the vehicle speed is less than the threshold of 20 km/h, the transmission controller 9 issues an operation command to the actuator 7 to perform a retry operation for switching the gear stage to the first gear stage. In the present embodiment, in a case where the vehicle speed is less than 20 km/h, the restraining body 64 of the transmission 6 restrains the gear stage to the first gear stage or the neutral gear stage. Therefore, in order to reduce the coasting sensation, the gear stage is preferably switched to the first gear stage. In a case where the vehicle speed is 20 km/h or more, the restraint of the gear stage by the restraining body 64 is easily released, and the second gear stage having a high gear ratio is suitable for a vehicle speed greater than that of the first gear stage having a low gear ratio. Therefore, the gear stage is preferably switched to the second gear stage. By setting the threshold of the vehicle speed in accordance with the restraining body 64 in this manner, the gear stage is smoothly switched. In an alternative embodiment, in a case where the transmission 6 does not have the restraining body 64, the threshold of the vehicle speed can be appropriately set according to the vehicle speed suitable for each gear stage.

For example, in a case where the rotation speed of the counter shaft 61 obtained from the counter shaft rotation speed sensor 20 is equal to or greater than the threshold of 600 rpm, the transmission controller 9 issues an operation command to the actuator 7 to perform retry operation for switching the gear stage to the second gear stage. On the other hand, in a case where the rotation speed of the counter shaft 61 is less than the threshold of 600 rpm, the transmission controller 9 issues an operation command to the actuator 7 to perform a retry operation for switching the gear stage to the first gear stage.

Alternatively, the transmission controller 9 may issue an operation command to the actuator to perform the retry operation according to the threshold of the rotation speed of the wheel 3 obtained from the wheel rotation speed sensor 18. The threshold of the rotation speed of the wheel 3 can be appropriately set according to the threshold of the vehicle speed or the threshold of the rotation speed of the counter shaft 61.

Alternatively, the transmission controller 9 may issue an operation command to the actuator to perform the retry operation according to the threshold of the rotation speed of the drive source output shaft 50 obtained from the drive source output shaft rotation speed sensor 19. The threshold of the rotation speed of the drive source output shaft 50 can be appropriately set according to the threshold of the vehicle speed or the threshold of the rotation speed of the counter shaft 61. For example, the threshold of the rotation speed of the drive source output shaft 50 may be set based on the rotation speed of the counter shaft 61, the gear ratio, and the gear ratio between the drive gear 51 and the driven gear 65.

The predetermined value includes a second predetermined value related to the acceleration of the vehicle 1. That is, the transmission controller 9 issues an operation command to the actuator 7 to perform the retry operation according to the second predetermined value. The second predetermined value includes the operation amount of the brake operator 10, the operation amount of the acceleration operator 11, and the acceleration of the vehicle 1.

For example, the transmission controller 9 issues an operation command to the actuator to perform the retry operation according to the threshold of the operation amount of the brake operator 10 obtained from the brake operation amount sensor 21. For example, in a case where the operation amount of the brake operator 10 is the threshold of 0%, that is, in a case where it is determined that the brake operator 10 is not operated, the transmission controller 9 issues an operation command to the actuator 7 to perform the retry operation for switching the gear stage to the second gear stage. On the other hand, in a case where the operation amount of the brake operator 10 is greater than the threshold of 0%, that is, in a case where it is determined that the brake operator 10 is operated, the transmission controller 9 issues an operation command to the actuator 7 to perform the retry operation for switching the gear stage to the first gear stage. Operating the brake operator 10 means an intention of the driver to decelerate. Therefore, in a case where the brake operator 10 is operated, the gear stage is preferably switched to the first gear stage suitable for a relatively low vehicle speed.

For example, the transmission controller 9 may issue an operation command to the actuator to perform the retry operation according to the operation amount of the acceleration operator 11 obtained from the acceleration operation amount sensor 22, that is, the threshold of the throttle opening. The threshold of the throttle opening is appropriately set according to the acceleration feeling obtained by various drivers. For example, in a case where the throttle opening is equal to or greater than a threshold, the transmission controller 9 issues an operation command to the actuator 7 to perform the retry operation for switching the gear stage to the second gear stage. On the other hand, in a case where the throttle opening is less than the threshold, the transmission controller 9 issues an operation command to the actuator 7 to perform the retry operation for switching the gear stage to the first gear stage. A relatively high throttle opening means an intention of the driver to accelerate. Therefore, in a case where the throttle opening is relatively high, the gear stage is preferably switched to the second gear stage suitable for a relatively high vehicle speed.

For example, the transmission controller 9 may issue an operation command to the actuator to perform the retry operation according to the threshold of the acceleration obtained from the acceleration sensor 25. The threshold of the acceleration is appropriately set according to the acceleration feeling obtained by various drivers. For example, in a case where the acceleration is equal to or greater than the threshold, the transmission controller 9 issues an operation command to the actuator 7 to perform the retry operation for switching the gear stage to the second gear stage. On the other hand, in a case where the acceleration is less than the threshold, the transmission controller 9 issues an operation command to the actuator 7 to perform the retry operation for switching the gear stage to the first gear stage.

Further, the transmission controller 9 may issue an operation command to the actuator 7 to perform the retry operation according to the attitude of the vehicle 1, that is, the bank angle. In a case where the vehicle 1 is inclined at a specific bank angle, such as a case where the vehicle 1 travels in a corner, it is preferable that the gear stage that has become a neutral gear stage unintentionally is switched to the gear stage before the shift command so that the vehicle speed does not change suddenly. For example, in a case where the bank angle of the vehicle 1 obtained from the vehicle posture sensor 23 is equal to or greater than 20°, the transmission controller 9 issues an operation command to the actuator 7 to perform the retry operation for switching the gear stage to the gear stage before the shift command. On the other hand, in a case where the bank angle is less than 20°, the transmission controller 9 may issue an operation command to the actuator 7 to perform the retry operation for switching the gear stage to the first gear stage or the second gear stage according to another predetermined value such as the vehicle speed, the acceleration or the like.

In addition, the transmission controller 9 may issue an operation command to the actuator 7 to perform the retry operation according to the intention of the driver's operation of the gear stage. For example, in a case where the shift command issued by the shift switch 8 is the upshift from the first gear stage to the second gear stage, the transmission controller 9 issues an operation command to the actuator 7 for the retry operation for switching the gear stage to the second gear stage. On the other hand, in a case where the shift command is the downshift from the second gear stage to the first gear stage, the transmission controller 9 issues an operation command to the actuator 7 to perform the retry operation for switching the gear stage to the first gear stage.

In addition, the transmission controller 9 may issue an operation command to the actuator 7 to perform the retry operation for switching the gear stage to the first gear stage or the second gear stage in accordance with the threshold of the temperature of the electric motor of the actuator 7 obtained from the temperature sensor 24 and the shift command issued by the shift switch 8. In general, when the temperature of the electric motor of the actuator 7 increases, it is possible that the output of the electric motor decreases, and the gear stage is not switched as desired, that is, the shift drum 15 may remain at an angle that does not correspond to any of the first to fourth shift rotation angles and the neutral angle. For example, in a case where the temperature of the electric motor of the actuator 7 is equal to or greater than the threshold of 80° C. and the shift command is the upshift from the first gear stage to the second gear stage, the transmission controller 9 issues an operation command to the actuator 7 to perform the retry operation for switching the gear stage to the first gear stage. For example, in a case where the temperature of the electric motor of the actuator 7 is equal to or greater than the threshold of 80° C. and the shift command is the downshift from the second gear stage to the first gear stage, the transmission controller 9 issues an operation command to the actuator 7 to perform the retry operation for switching the gear stage to the second gear stage. That is, in a case where the temperature of the electric motor of the actuator 7 is equal to or greater than 80° C., the transmission controller 9 issues an operation command for the retry operation for switching the gear stage that has unintentionally become the neutral gear stage to the gear stage before the shift command. As a result, since the gear stage is switched with the output of the electric motor as small as possible, the number of retry operations is reduced, and free-running travel is easily reduced. The threshold of the temperature of the electric motor may vary depending on the type of actuator 7 to be used.

Each of the above thresholds can be appropriately set according to the specification of the vehicle 1, the use of the vehicle 1, and the like. These thresholds may be incorporated in advance in a program constituting the threshold comparison unit 9d of the transmission controller 9, or may be appropriately input by a driver or a dealer via an input/output interface circuit of the transmission controller 9.

The transmission controller 9 may issue an operation command for the retry operation to the actuator 7 based on a plurality of comparison results obtained by comparing each predetermined value described above with a threshold corresponding to the predetermined value. Specifically, among the plurality of comparison results, a comparison result to be prioritized may be determined in advance, and the transmission controller 9 may issue an operation command to the actuator 7 to perform the retry operation so as to switch to a preferred gear stage based on the comparison result.

For example, in a case where the shift command is downshift but the vehicle speed is equal to or greater than 20 km/h, the transmission controller 9 gives priority to the comparison result of the vehicle speed, and issues an operation command to the actuator 7 to perform the retry operation for switching the gear stage to the second gear stage.

In addition, for example, in a case where the shift command is the downshift but the bank angle is equal to or greater than 20°, the transmission controller 9 gives priority to the comparison result of the bank angle, and issues an operation command to the actuator 7 to perform the retry operation for switching the gear stage to the gear stage before the shift command, for example, the second gear stage.

The gear stage determination unit 9c determines, based on the rotation angle of the shift drum 15, whether the gear stage is switched to the first gear stage or the second gear stage after the actuator 7 operates based on the operation command for the retry operation. In a case where it is determined that the gear stage is still in the neutral gear stage, the transmission controller 9 issues an operation command to the actuator 7 to perform the retry operation again via the communication unit 9a.

The retry count determination unit 9e counts the number of retry operations. The retry count determination unit 9e determines whether the number of retry operations has reached a predetermined number. In a case where it is determined that the number of retry operations has reached the predetermined number, the transmission controller 9 stops the operation command of the retry operation. That is, the operation command for the further retry operation is not generated by the operation command generation unit 9b. In a case where the gear stage cannot be switched to the first gear stage or the second gear stage due to some structural factor in the transmission 6, it is not preferable that the actuator 7 is repeatedly operated without an upper limit. By providing an upper limit to the number of retry operations, mechanical damage due to structural factors can be avoided.

When the power of the transmission controller 9 is turned off, the transmission controller 9 resets the number of retry operations. Specifically, after the drive source 5 is stopped and the power is not supplied from the battery of the vehicle 1 to the transmission controller 9, when the drive source 5 is restarted and the power is supplied to the transmission controller 9, the number of retry operations is reset. The number of retry operations is also reset when the gear stage is switched from the neutral gear stage. For example, even in a case where the number of retry operations reaches a predetermined number and the operation command of the retry operation is stopped, when the gear stage is switched by the operation of the shift switch 8 by the driver, the number of retry operations is reset.

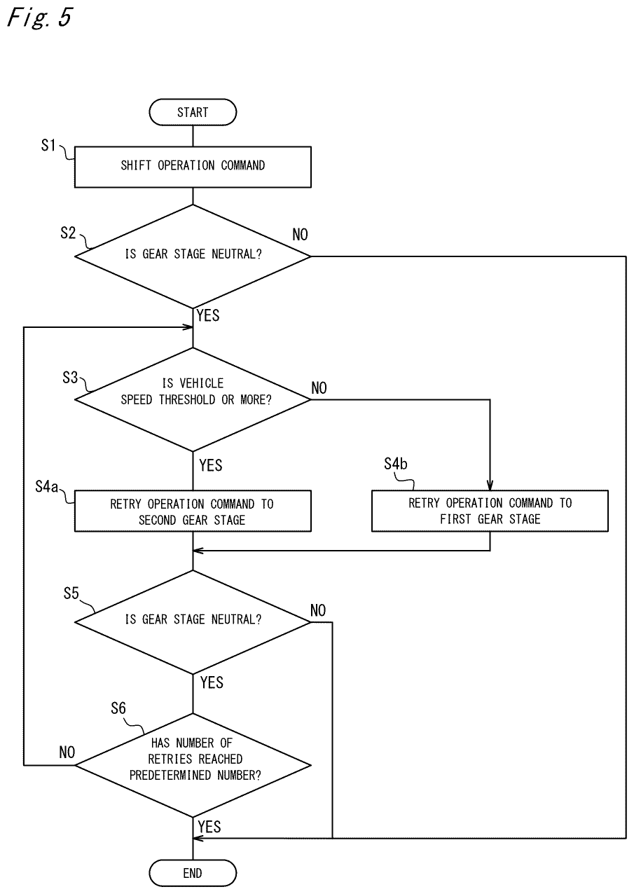

Next, a method of controlling the transmission 6 using the transmission controller 9 will be described with reference to the flowchart illustrated in FIG. 5. Hereinafter, as an example, a transmission control method in a case where a predetermined value indicating a traveling state of the vehicle 1 is a vehicle speed will be described.

First, in step S1, when the driver operates the shift switch 8 during driving of the vehicle 1, an operation command for the shift operation is generated by the operation command generation unit 9b and transmitted to the actuator 7 via the communication unit 9a. In this example, the transmission controller 9 executes the operation command of the shift operation of an upshift from the first gear stage to the second gear stage.

Based on the operation command of the shift operation, the actuator 7 rotates the shift drum 15 so that the rotation angle of the shift drum 15 becomes the second shift rotation angle. Next, in step S2, the gear stage determination unit 9c recognizes the rotation angle of the shift drum 15 after the operation of the actuator 7 by the gear position sensor 26, and determines whether the gear stage is in the neutral gear stage.

In a case where it is recognized that the gear stage is not in the neutral gear stage, that is, in a case where it is recognized that the gear stage is switched to the second gear stage in this example, the transmission controller 9 does not issue a further operation command to the actuator 7, and the process ends.

In a case where it is recognized that the gear stage is in the neutral gear stage, in step S3, the threshold comparison unit 9d compares the vehicle speed input from the vehicle speed sensor 17 with a threshold (for example, 20 km/h). In a case where the vehicle speed is equal to or greater than the threshold, in step S4a, the retry operation for switching to the second gear stage is generated by the operation command generation unit 9b and transmitted to the actuator 7 via the communication unit 9a. In a case where the vehicle speed is less than the threshold, in step S4b, the retry operation for switching to the first gear stage is generated by the operation command generation unit 9b and transmitted to the actuator 7 via the communication unit 9a.

After steps S4a and S4b, in step S5, the gear stage determination unit 9c recognizes the rotation angle of the shift drum 15 again and determines whether the gear stage is in the neutral gear stage. In a case where it is recognized that the gear stage is not in the neutral gear stage, that is, in a case where it is recognized that the gear stage has been switched to the first gear stage or the second gear stage, the transmission controller 9 does not issue a further operation command to the actuator 7, and the process ends.

In a case where it is recognized that the gear stage is in the neutral gear stage, in step S6, the retry count determination unit 9e counts the number of times of retry operation (referred to as the number of retries) and determines whether the number of retries has reached a predetermined number. In a case where it is determined that the number of retries has not reached the predetermined number, the transmission controller 9 executes the process from step S3 again. In a case where it is determined that the number of retries has reached the predetermined number, the transmission controller 9 does not issue a further operation command to the actuator 7, and the process ends.

As described above, in a case where the gear stage is unintentionally set to the neutral gear stage, the transmission is automatically switched by the transmission controller 9, so that free-running travel can be reduced. As a result, the driver can obtain a sense of traveling.

These processes by the transmission controller 9 also depend on the processing capability of the transmission controller 9, but are executed in a few seconds. Therefore, in a case where the gear stage is unintentionally set to the neutral gear stage, the time during which the gear stage is set to the neutral gear stage is short. Therefore, the driver can travel comfortably without feeling the free-running state.

In an alternative control method, after it is determined in step S6 that the number of retries has not reached the predetermined number, the transmission controller 9 may issue an operation command to the actuator 7 to perform the same retry operation as the retry operation performed before step S6 without comparing the vehicle speed with the threshold. In other words, after it is determined as NO in step S6, the transmission controller 9 may skip step S3 and issue an operation command to the actuator 7 to perform the same retry operation as the previous retry operation.

The transmission controller 9 and the vehicle 1 according to the present embodiment achieve the following effects.
(1) The transmission controller 9 that issues an operation command for switching a gear stage to the actuator 7 in the vehicle 1 including:
the drive wheel 3b;
the drive source 5 that generates a driving force for rotating the drive wheel 3b;
the transmission 6 that transmits the driving force to the drive wheel 3b by a specific gear stage selected from a plurality of gear stages including at least the first gear stage, the second gear stage having a higher gear ratio than a gear ratio of the first gear stage, and the neutral gear stage not transmitting the driving force; and
the actuator 7 that operates to selectively switch gear stages,
wherein the transmission controller 9 issues to the actuator 7 an operation command including:
a shift operation for switching the gear stage to the first gear stage or the second gear stage; and
a retry operation for switching the gear stage to the first gear stage or the second gear stage according to a predetermined value indicating a traveling state of the vehicle 1 in a case where the gear stage switched based on the shift operation becomes the neutral gear stage contrary to the shift operation.

As a result, even in a case where the gear stage becomes the neutral gear stage contrary to the intention of the driver, an operation command is issued to the actuator 7 to perform the retry operation for switching the gear stage to the first gear stage or the second gear stage according to the traveling state of the vehicle 1. Therefore, it is possible to reduce the likelihood that the gear stage becomes an unintended neutral gear stage during traveling, and it is possible to reduce a state of so-called free-running in which the vehicle travels in the neutral gear stage.
(2) The predetermined value includes a first predetermined value related to the vehicle speed of the vehicle 1.

As a result, the gear stage is switched to a preferable gear stage according to the first predetermined value related to the vehicle speed.
(3) The first predetermined value includes a vehicle speed,
the transmission 6 includes the restraining body 64 for restraining the gear stage to the first gear stage or the neutral gear stage in a case where the vehicle speed is less than a specific vehicle speed, and
in a case where the vehicle speed is less than a specific vehicle speed, the transmission controller 9 issues an operation command to the actuator 7 to perform a retry operation for switching the gear stage to the first gear stage.

In a case where the transmission 6 includes such the restraining body 64, the retry operation is performed based on a specific vehicle speed corresponding to the restraining body 64, so that the gear stage can be smoothly switched.
(4) The transmission 6 includes the main shaft 60 to which the driving force is input and the counter shaft 61 to which the driving force is transmitted from the main shaft 60,
the first predetermined value includes the rotation speed of the counter shaft 61,
the transmission 6 includes the restraining body 64 for restraining the gear stage to the first gear stage or the neutral gear stage in a case where the rotation speed of the counter shaft 61 is less than a specific rotation speed, and
in a case where the rotation speed of the counter shaft 61 is less than the specific rotation speed, the transmission controller 9 issues an operation command to the actuator 7 to perform the retry operation for switching the gear stage to the first gear stage.

In a case where the transmission 6 includes such the restraining body 64, the retry operation is performed based on the specific rotation speed of the counter shaft 61 corresponding to the restraining body 64, so that the gear stage can be smoothly switched.
(5) The predetermined value includes a second predetermined value related to the acceleration of the vehicle 1.

As a result, the gear stage is switched to a preferable gear stage according to the second predetermined value related to the acceleration.
(6) In a case where the number of retry operations during traveling of the vehicle 1 reaches a predetermined number, the transmission controller 9 stops the operation command of the retry operation.

As a result, in a case where the transmission 6 cannot perform switching of the neutral gear stage due to some structural factor, the operation command of the retry operation can be stopped. This makes it possible to avoid mechanical damage to the transmission 6 due to repeated retry operations.
(7) The number of retry operations is reset when the power of the transmission controller 9 is turned off or when the gear stage is switched from the neutral gear stage.

In a case where the neutral gear stage can be switched after the power of the transmission controller 9 is turned off, or in a case where the neutral gear stage is switched by the shift command, the transmission controller 9 can issue the operation command of the retry operation again.
(8) The vehicle 1 includes:
the drive wheel 3b;
the drive source 5 that generates a driving force for rotating the drive wheel 3b;
the transmission 6 that transmits the driving force to the drive wheel 3b by a specific gear stage selected from a plurality of gear stages including at least the first gear stage, the second gear stage having a higher gear ratio than a gear ratio of the first gear stage, and the neutral gear stage not transmitting the driving force;
the actuator 7 that operates to selectively switch gear stages; and
the transmission controller 9 that issues an operation command to the actuator 7 for switching a gear stage,
wherein the transmission controller 9 issues to the actuator 7 an operation command including:
a shift operation for switching the gear stage to the first gear stage or the second gear stage; and
a retry operation for switching the gear stage to the first gear stage or the second gear stage according to a predetermined value indicating a traveling state of the vehicle 1 in a case where the gear stage switched based on the shift operation becomes the neutral gear stage contrary to the shift operation.

As a result, even in a case where the gear stage becomes the neutral gear stage contrary to the intention of the driver, an operation command is issued to the actuator 7 to perform the retry operation for switching the gear stage to the first gear stage or the second gear stage according to the traveling state of the vehicle 1. Therefore, it is possible to reduce the likelihood that the gear stage becomes an unintended neutral gear stage during traveling, and it is possible to reduce a state of so-called free-running in which the vehicle travels in the neutral gear stage.

Note that the transmission controller and the vehicle according to the present disclosure are not limited to the configurations of the above embodiments, and various modifications can be made.

In the present specification, the motorcycle has been described as an example of a vehicle, but the vehicle is not limited to the motorcycle. The vehicle may be a straddled vehicle including the motorcycle, or a four-wheeled motor vehicle. When the vehicle is a four-wheeled motor vehicle, the brake operator may be a brake pedal and the acceleration operator may be an accelerator pedal.

The shift operation of the transmission need not be a manual operation by the shift switch. The shift operation may be automatically performed in accordance with the vehicle speed.

The transmission may not include the restraining body described in the present embodiment. The technology of the present disclosure can also be suitably applied to a transmission having no restraining body.

The threshold may be constant or variable. The threshold may change according to various predetermined values indicating the traveling state of the vehicle. For example, the threshold of the vehicle speed in the case of the shift command by the upshift may be different from the threshold of the vehicle speed in the case of the shift command by the downshift.

The gear position sensor 26 may be attached to the shift fork 14. In this case, the gear stage at the present time may be recognized by the position of the shift fork 14 in the axial direction.

What is claimed is

1. A transmission controller that issues an operation command for switching a gear stage to an actuator in a vehicle, the vehicle comprising:
a drive wheel;
a drive source that generates a driving force for rotating the drive wheel;
a transmission that transmits the driving force to the drive wheel by a specific gear stage selected from a plurality of gear stages including at least a first gear stage, a second gear stage having a higher gear ratio than a gear ratio of the first gear stage, and a neutral gear stage not transmitting the driving force; and
an actuator that operates to selectively switch gear stages,
wherein the transmission controller issues to the actuator an operation command including:
a shift operation for switching the gear stage to the first gear stage or the second gear stage; and
a retry operation for switching the gear stage to the first gear stage or the second gear stage according to a predetermined value indicating a traveling state of the vehicle in a case where the gear stage switched based on the shift operation becomes the neutral gear stage contrary to the shift operation.

2. The transmission controller according to claim 1, wherein the predetermined value includes a first predetermined value related to a vehicle speed of the vehicle.

3. The transmission controller according to claim 2, wherein
the first predetermined value includes the vehicle speed,
the transmission includes a restraining body for restraining the gear stage to the first gear stage or the neutral gear stage in a case where the vehicle speed is less than a specific vehicle speed, and
in a case where the vehicle speed is less than the specific vehicle speed, the transmission controller issues an operation command to the actuator to perform the retry operation for switching the gear stage to the first gear stage.

4. The transmission controller according to claim 2, wherein
the transmission includes a main shaft to which the driving force is input and a counter shaft to which the driving force is transmitted from the main shaft,
the first predetermined value includes a rotation speed of the counter shaft,
the transmission includes a restraining body for restraining the gear stage to the first gear stage or the neutral gear stage in a case where the rotation speed of the counter shaft is less than a specific rotation speed, and
in a case where the rotation speed of the counter shaft is less than the specific rotation speed, the transmission controller issues an operation command to the actuator to perform the retry operation for switching the gear stage to the first gear stage.

5. The transmission controller according to claim 1, wherein the predetermined value includes a second predetermined value related to an acceleration of the vehicle.

6. The transmission controller according to claim 1, wherein in a case where the number of retry operations during traveling of the vehicle reaches a predetermined number, the transmission controller stops the operation command of the retry operation.

7. The transmission controller according to claim 6, wherein the number of retry operations is reset when a power of the transmission controller is turned off or when the gear stage is switched from the neutral gear stage.

8. A vehicle comprising:
a drive wheel;
a drive source that generates a driving force for rotating the drive wheel;
a transmission that transmits the driving force to the drive wheel by a specific gear stage selected from a plurality of gear stages including at least a first gear stage, a second gear stage having a higher gear ratio than a gear ratio of the first gear stage, and a neutral gear stage not transmitting the driving force;
an actuator that operates to selectively switch gear stages; and
a transmission controller that issues an operation command to the actuator for switching a gear stage,
wherein the transmission controller issues to the actuator an operation command including:
a shift operation for switching the gear stage to the first gear stage or the second gear stage; and
a retry operation for switching the gear stage to the first gear stage or the second gear stage according to a predetermined value indicating a traveling state of the vehicle in a case where the gear stage switched based on the shift operation becomes the neutral gear stage contrary to the shift operation.
